(19) United States
(12) Patent Application Publication
(10) Pub. No.: US 2007/0088584 A1
(43) Pub. Date: Apr. 19, 2007

(54) Systems and methods for managing lifecycle costs of an asset inventory

(76) Inventors: James Kenneth Aragones, Clifton Park, NY (US); Naresh Sundaram Iyer, Clifton Park, NY (US); Amy Victoria Aragones, Clifton Park, NY (US)

Correspondence Address: Patrick S. Yoder;FLETCHER YODER, P.O. Box 692289, Houston, TX, 77269-2289, US

(21) Appl. No.: 11/253,136

(22) Filed: Oct. 18, 2005

(51) Int. Cl. G06F 9/44

(52) U.S. Cl. 705/7

(57) ABSTRACT

A method of managing lifecycle costs for an asset inventory is provided. The method includes obtaining data related to assets for the asset inventory and analyzing the obtained data to generate a plurality of domain-dependent rules having parameters corresponding to assets of the asset inventory. The method also includes determining an optimal setting of the parameters to achieve an estimated least-cost value of owning the assets over a period of time and applying the optimal setting of the parameters to each asset to generate customized asset parameters.

### BACKGROUND

The present invention relates generally to a technique for managing lifecycle costs for an asset inventory and, more particularly, to methods and systems for optimizing an asset management schedule for a vehicle inventory, such as a fleet of aircraft in order to reduce the associated lifecycle costs. Indeed, although the following discussion focuses on vehicles, the present invention is applicable to a host of devices, ranging from appliances to complex vehicles.

Various service organizations establish long-term contractual agreements with their customers, contracting to provide a broad scope of services for a given term. For example, engine services organizations often establish long-term service agreements (LTSA's) with airlines, among other entities, to provide most maintenance requirements for the engines of an airline's fleet. Thus, if an engine requires maintenance or repair during the contractual term, the LTSA requires the service organization to properly address such issue. The cost of the long-term service agreement for a fleet of engines is dependent upon the cost associated with overhauling the engines in the fleet. Typically, the total overhaul cost incurred on a fleet of engines within the scope of LTSA is the sum of individual costs incurred on each of the engines in the fleet during their maintenance visits to the engine shop. There are other additional costs incurred as a part of the LTSA cost as well.

Traditionally, components of an aircraft engine are replaced only upon failure of a given component, with the replacement occurring during a maintenance visit. However, replacing only the failed components might result in a relatively low reliability of the engine, because a currently operationally satisfactory (i.e., healthy) part is statistically likely to fail in the near future. Thus, it has been found, in various instances, it is desirable to address possible problem in parts that are viewed as healthy, as having a failure in such a part since it controls the amount of life that gets added to the engine when it goes back on-wing (i.e., reassembled with respect to the aircraft). In general, individual strategies or plans for each engine in the fleet are developed for managing an entire fleet of engines over its life cycle to achieve a relatively low cost of managing the inventory. However, the process of planning is relatively complicated due to the fact that engines can fail due to multiple reasons and each failure mode may be related to a separate engine part. Further, the locally optimal plan for an engine in the fleet may not belong to the set of globally optimal plans for the entire fleet.

Additionally, different engines operate under different environmental conditions, and the environment within which each engine operates also decides its time of removal in addition to other factors such as economy, shop capacity and overhaul time. Thus, the process of finding the best plan for managing the fleet of engines involves search in the space of the multitude of factors. Further, the complexity of the optimization search for individual engines increases with the dimensionality of the search as the fleet size increases.

Therefore, there is a need for an improved technique for managing an asset inventory. Particularly, there is a need for systems and methods that reduce the total cost of owning the asset inventory.

### BRIEF DESCRIPTION

In accordance with one exemplary embodiment, the present technique provides a method of managing lifecycle costs of an asset inventory. The method includes obtaining data related to assets for the asset inventory and analyzing the obtained data to generate a plurality of domain-dependent rules having parameters corresponding to assets of the asset inventory. The method also includes determining an optimal setting of the parameters to achieve an estimated least-cost value of owning the assets over a period of time and applying the optimal setting of the parameters to each asset to generate customized asset parameters.

In accordance with another exemplary embodiment, the present technique provides a system for managing the lifecycle costs of an asset inventory. The system includes a database having data related to assets of the asset inventory and an expert system comprising a plurality of domain-dependent rules corresponding to the assets of the asset inventory, wherein each of the domain-dependent rules is associated with a plurality of parameters. The system also includes an optimization module configured to determine an optimal setting of the parameters to achieve an estimated least-cost value of owning the assets over a period of time.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an exemplary service cycle for a fleet of engines, in accordance with an embodiment of the present technique;

FIG. 2 is a diagrammatical representation of an overhaul process of the aircraft engines for the fleet of engines of FIG. 1, in accordance with an embodiment of the present technique;

FIG. 3 is a diagrammatical representation of a system-level simulation architecture for determining the shop load distribution and cost of owning the engines for the fleet of engines of FIG. 1, in accordance with an embodiment of the present technique;

FIG. 4 is a diagrammatical illustration of a system for managing an inventory of a fleet of engines, in accordance with an exemplary embodiment of the present technique;

FIG. 5 illustrates an exemplary repair matrix for an engine corresponding to different failure modes of the engine, in accordance with an exemplary embodiment of the present technique; and

FIG. 6 illustrates exemplary repair strategies for an engine subjected to random and life limiting part failure modes, in accordance with an exemplary embodiment of the present technique.

### DETAILED DESCRIPTION

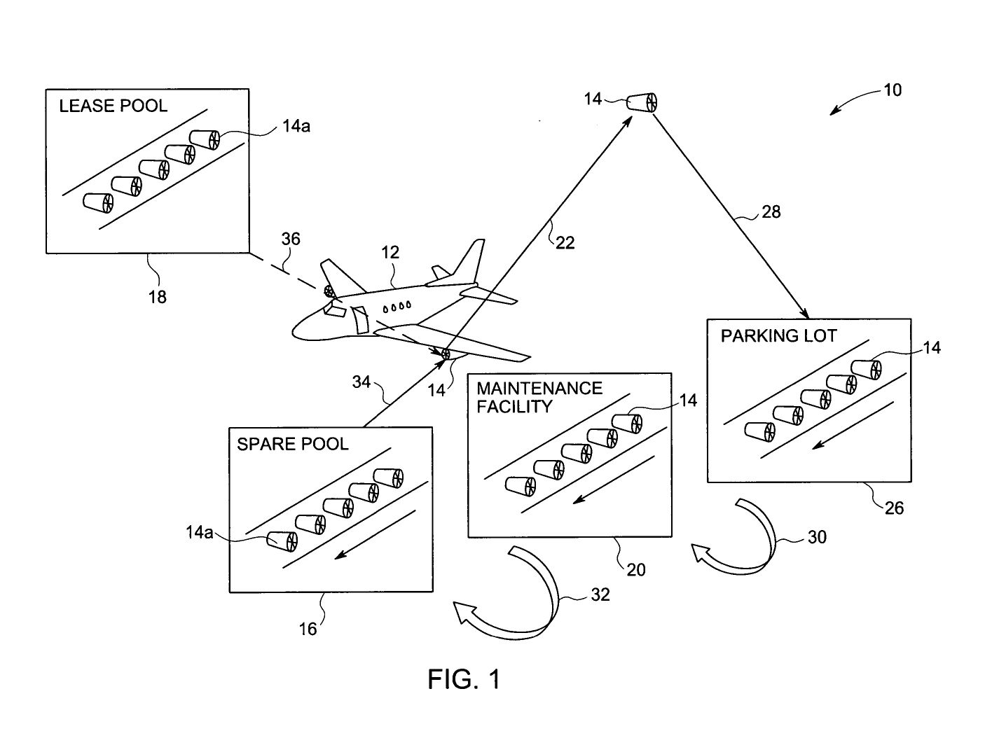

As discussed in detail below, embodiments of the present invention function to provide a method of managing an asset inventory for a product. Although the present discussion focuses on managing lifecycle costs for a fleet of aircraft, the present technique is not limited to engines. Rather, the present technique is applicable to any number of suitable fields in which lifecycle cost management for a fleet of assets is desired. Referring now to the drawings, FIG. 1 illustrates an exemplary service cycle 10 of an engine fleet of an aircraft 12. For illustration purposes, only one aircraft 12 of an aircraft fleet is shown, however, in practice the aircraft fleet may include any number of aircrafts. From time-to-time, it may become necessary to remove one or more engines 14 from the aircraft 12. For example, the engine 14 may be removed from the aircraft 12 for an overhaul of the components of the engine 14, because of improper operation of the engine 14, because of routine or preventive maintenance, among a host of conditions. As a result, a replacement engine 14a may be required for an uninterrupted operation of the aircraft 12.

Typically, the replacement engine 14a is provided through a spare pool 16 that includes a plurality of stand-by engines. It should be noted that an airline or a service provider for the airline owns an appropriate number of engines in the spare pool 16 that may be utilized as replacement engines 14a for the aircraft 12, for example. Alternatively and by way example, if the replacement engine 14a is not available via the spare pool 16, then the replacement engine 14a may be leased from a lease pool 18 for a required time period. Often, lease pools 18 are operated by a third-party.

Once removed from the aircraft 12, the engine 14 is often transported to a maintenance facility or a shop 20 for overhauling or repair, as represented by reference numerals 22. Typically, the removed engine 14 is placed in a “parking lot” 26 (i.e., an interim storage facility), as represented by reference numeral 28. When placed in the parking lot 26, the removed engine 14 enters a queue for transportation to the maintenance facility 20 for maintenance. Depending on the availability of space at the maintenance facility 20, the engine 14 enters the facility 20 for maintenance, as represented by reference numeral 30. In certain embodiments, if the parking lot is empty, the removed engine 14 may be directly transported to the maintenance facility 20.

Subsequently, the removed engine 14, once appropriately addressed, may be stored in the spare pool 16, as represented by reference numeral 32. Accordingly, the overhauled engine 14 from the spare pool 16 may be employed as the replacement engine 14a for the aircraft 12, as represented by reference numeral 34. As mentioned before, if a spare engine is not available in the spare pool 16, the engine 14 may be leased or purchased from the lease pool 18, as represented by reference numeral 36. Also, if the number of engines in the spare pool 16 falls below a given contractual threshold, it may be necessary to lease or purchase additional engines from the lease pool 18. When a spare engine is available for use as a replacement engine 14a, leased engines from the lease pool 18 may be returned by replacing it with a newly repaired spare engine from the spare pool 16.

As described above, from time-to-time the engine 14 may be removed for each aircraft 12 of a fleet for maintenance. The total overhaul cost incurred on a fleet of engines 14 is the sum of individual costs incurred on each of the engines 14. The total cost of owning and maintaining the fleet of engines 14 may be optimized by developing an optimal fleet strategy for the fleet of engines 14 as described below.

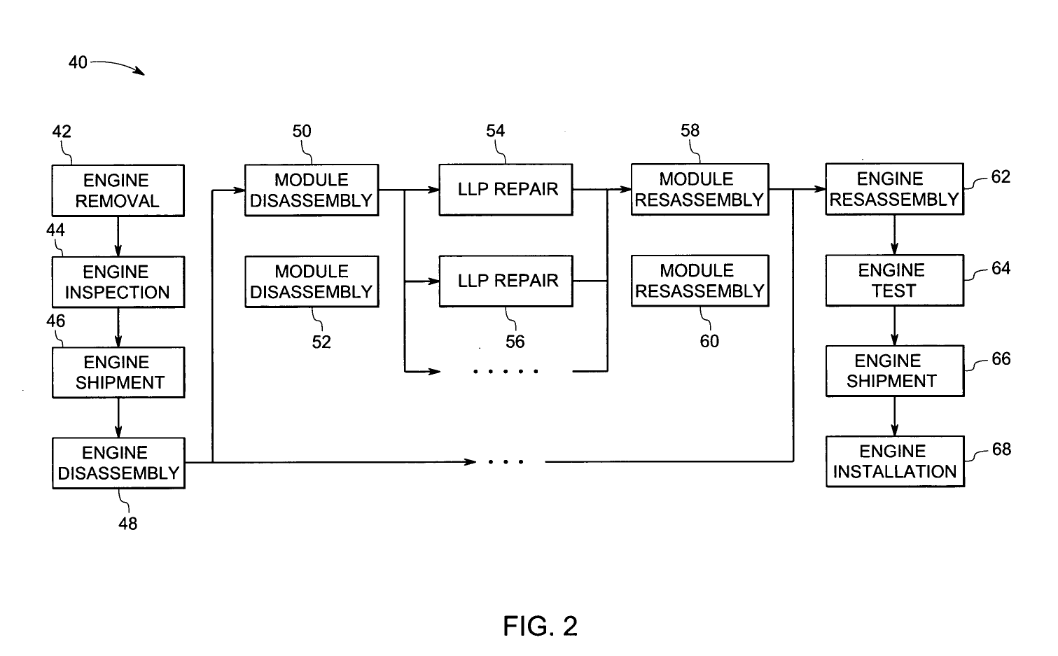

FIG. 2 is a diagrammatical representation of an overhaul process 40 of the aircraft engines 14 for the fleet of engines of FIG. 1, in accordance with an embodiment of the present technique. Typically, when an engine 14 fails or is predicted to fail, the engine 14 is removed from the aircraft 12 as represented by step 42. Further, the removed engine 14 is sent to the maintenance facility 20 for maintenance. In the illustrated embodiment, the removed engine 14 is inspected for determination of failed components for the different modules or compartments of the engine 14 (step 44). It should be noted that based upon the condition of the different modules of the engine they may be subjected to one of several actions from inspection, repair or replacement. Further, each of these actions has different cost associated with it.

Once the modules of the engine 14 are inspected the engine 14 may be shipped to a facility for engine disassembly, as represented by steps 46 and 48. The engine 14 is disassembled into a plurality of modules that may be further disassembled into components for repair. Examples of such modules include the combustion section, the low-pressure turbine section, the high-pressure turbine section and so forth. Additionally, the plurality of modules of the engine 14 may be disassembled into a plurality of components as represented by steps 50 and 52. In the illustrated embodiment, two modules of the engine 14 are illustrated. However, the engine 14 may be disassembled into any number of modules for inspection.

The components of each of the plurality of modules may be subjected to repair (steps 54, 56). In the illustrated embodiment, the components to be repaired include “life limited” parts. As used herein, the term “life limited” parts refers to the parts of the engine 14 that are manufactured with substantially high reliability and life of such parts can be predicted based upon the operating conditions of the engine. In an alternate embodiment, the components to be repaired include parts failed due to random failures. The life of the parts that fail due to random failures may be determined by employing probabilistic methods. More specifically, the probabilistic distributions for such failures are determined by using Weibull life analysis on existing failure data.

Moreover, the repaired components of the engine 14 are subsequently reassembled into modules as represented by steps 58 and 60. Further, the engine 14 may be reassembled with the assembled modules having the repaired components (step 62). In the illustrated embodiment, the assembled engine may be subjected to engine testing as represented by step 64. Subsequently, the engine 14 is shipped and is installed on a particular aircraft 12, as represented by steps 66 and 68. Thus, over a time period the maintenance facility 20 may receive a plurality of engines 14 for repair. The cost of overhaul of these engines depends upon the costs incurred on each of the individual engines.

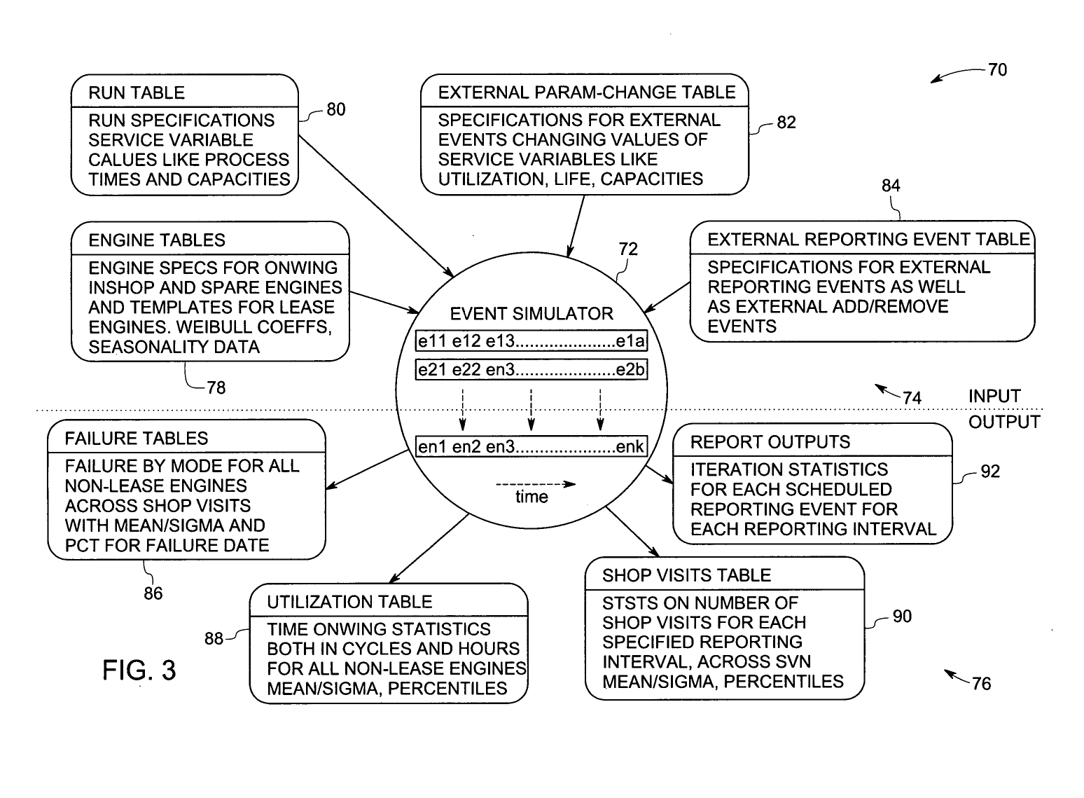

In operation, a plurality of repair strategies may be devised for repair of the engines 14 based upon the failure mode and the condition of the engine 14. As used herein, the term “strategy” refers to a set of decisions for each component of each engine corresponding to a set of conditions. In the illustrated embodiment, data related to the fleet of engines is analyzed to develop the repair strategies for the fleet. Particularly, such data related to the engine 14 is analyzed to generate a plurality of “domain-dependent” rules having parameters corresponding to the each of the engines 14. As used herein, the term “domain-dependent” rules refer to a sequence of actions related to maintenance of the engine 14 to achieve a desired goal. In the illustrated embodiment, parameters corresponding to the domain-dependent rules are evaluated to determine a combination of parameters that minimizes the cost of repair of the engine 14. For example, for commercial aircraft engines the domain-dependent rules that affect engine overhaul may include pre-determined maintenance intervals for specific components of the engine. In certain embodiments, the domain-dependent rules affecting the engine overhaul may include the selection of the replacement parts. For example, the replacement parts may be selected from new, used, new upgrade, and used upgrade parts. In certain embodiments, the domain-dependent rules may include a priority level assigned to a customer. However, other types of domain-dependent rules affecting a desired output may be envisaged. The cost of repair of the engines 14 also depends upon the timing and cost of service events of the fleet of engines 14. The engine service planning may be performed based upon a simulation for determining the shop load distribution and the cost of owning and maintaining the engines 14 for the fleet of engines as described below with reference to FIG. 3.

FIG. 3 is a diagrammatical representation of a system-level simulation architecture 70 for determining the shop load distribution and cost of owning the engines 14 for the fleet of engines of FIG. 1, in accordance with an embodiment of the present technique. Such a system having the simulation architecture is described in U.S. Pat. No. 6,799,154, which is incorporated herein by reference. In the illustrated embodiment, an event simulator 72 receives required inputs 74 from a set of input tables and writes the scheduled outputs 76 to the appropriate output tables. The exemplary input tables 74 include information related to the fleet of engines on which the simulation is to be run. The input tables 74 also include engine tables 78, and a run table 80. Further, the input tables 74 also include an external parameter change table 82 and an external reporting event table 84. The engine tables 78 include the engine configurations for the on-wing, spare and in-shop engines at the beginning of the simulation. Further, the engine tables 78 also include configuration templates to be employed for leasing an engine. In certain embodiments, the engine tables 78 may include other data, such as, Weibull coefficients, seasonality data and so forth.

Moreover, the run table 80 includes simulation variables such as the number of iterations and simulation start date. The run table 80 also includes variables related to the service cycle of the engine 14. For example, the run table 80 may include time distributions for overhauls, engine transport and maintenance facility capacity. Further, the external parameter change tables 82 allows a user to schedule external events that may be used to change service and fleet variables like utilization upgrades, coefficient upgrades, maintenance facility capacity and so forth.

In the illustrated embodiment, the external reporting event table 84 allows the user to specify reporting events. Further, the external reporting event table 84 also provides the flexibility to the user to add or remove external events. The event simulator 72 performs the simulation based upon the inputs 74 and writes the results to the output tables 76. As will be appreciated by one skilled in the art depending upon the type of the output 76, there may be a plurality of output tables to which the results are written.

The output tables 76 include failure tables 86 that include the engine failure dates by failure modes that result from running the simulation. It should be noted that the engine failure dates are predicted by the simulator 72 at which the removal events are scheduled by the event simulator 72. Further, each engine 14 of the fleet may have more than a single failure distribution corresponding to each shop visit of the engine 14. Further, the output tables 76 also include a utilization table 88 and a shop visits table 90. The utilization table 88 includes statistics for flight hours and flight cycles for each engine by failure mode. Moreover, the shop visits table 90 includes statistics related to the number of shop visits, by failure mode, that are expected to occur within a time interval during the forecasting period. In the illustrated embodiment, the event simulator 72 may also generate report outputs 92. The report outputs 92 may include the iteration statistics for the simulation for each scheduled reporting event for each reporting interval. In a present embodiment, the output 76 of the simulation is utilized to determine shop load distributions for a forecasting period and expected cost of owning engines 14. Further, the input 74 is also utilized by an expert system to generate domain-dependent rules for the fleet of engines. For instance, since a fleet can be composed of a mix of engine configurations depending upon their absolute age, utilization profile, previous overhaul history, the rules may identify a distinct family of repair strategy for each set of engines belonging to a particular configuration. The same categorization might also preclude some of the configurations from qualifying for assembly upgrades during overhaul. These rules are derived from historical as well as domain knowledge related to engine configurations. In certain embodiments, the chosen family of repair strategy for a given configuration might contain engine parameters that are empirical and approximate. Such domain-dependent rules include parameters associated with each of the rules. Further, the parameters for the domain-dependent rules may be used to achieve an estimated least-cost value as described below. The optimization module estimates more precisely the parameter values that result in minimal lifecycle cost for the fleet.

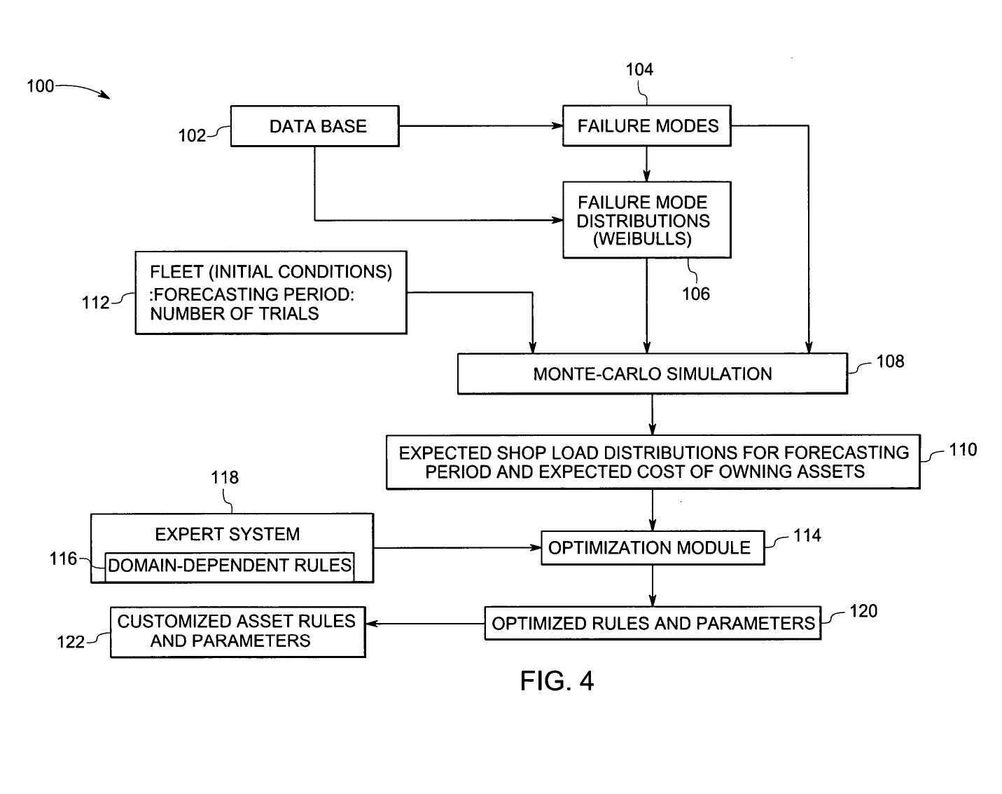

FIG. 4 is a diagrammatical illustration of a system 100 for managing an inventory of the fleet of engines of FIG. 1, in accordance with an exemplary embodiment of the present technique. The system 100 includes a database 102 having historical failure data related to the components of the engines. Examples of such data include an engine utilization, or an engine lease acquisition cost, or an engine lease utilization cost, or an engine repair cost, or an engine life, or an engine maintenance turnaround time, or an engine transport time, or an engine depreciation, or an engine purchase cost, or an engine storage cost, or an engine ownership cost, or combinations thereof. In the illustrated embodiment, the system 100 utilizes the historical failure data from the database 102 and failure modes 104 for the components of the engine to determine Weibull distributions 106 for each of the failure modes 104. Examples of failure modes include gear box related failure, combustor failure, foreign object damage, high pressure compressor failure, high pressure turbine failure, life limited part, low pressure system failure, maintenance error, slow acceleration and combinations thereof.

Further, a Monte Carlo simulation 108 may be employed to determine shop load distributions 110 over the time period. In this embodiment, the Monte Carlo simulation utilizes parameters 112 such as initial fleet conditions, forecasting period and number of trials to determine the shop load distributions 110 for the forecasting period. The estimated shop load distributions 110 along with certain other aforementioned parameters are utilized for managing the spare engine inventory for the fleet of engines. In one embodiment, the Monte Carlo simulation 108 is employed to determine the cost of owning a fleet of engines based upon the estimated shop load distribution.

The system 100 also includes an optimization module 114 that receives information related to the domain-dependent rules 116 from an expert system 118. In the illustrated embodiment, each of the domain-dependent rules 116 is associated with a plurality of parameters. Further, based upon the expected shop load distributions and the domain-dependent rules 116 the optimization module 114 is configured to determine an optimal setting of the parameters to achieve an estimated least-cost value of owning the engines over a period of time. The optimization module 114 employs an optimization technique such as a linear program, or a heuristic method or a genetic algorithm to determine the optimal setting of the parameter. However, other optimization techniques are within the scope of the present invention. Thus, the optimization module 114 determines optimized rules and parameters 120 for the fleet of engines.

Further, the optimized rules and parameters are subsequently applied to each engine for generating customized asset rules and parameters 122. It should be noted that the customized asset rules and parameters for the individual engine facilitate achieving the estimated least-cost value of owning the engines. Particularly, the customized asset rules and parameters facilitate development of management strategies for achieving the estimated least-cost value of owning the engines. In the illustrated embodiment, an optimal repair strategy for each engine may be developed based upon the domain-dependent rules and the operating conditions of the engine.

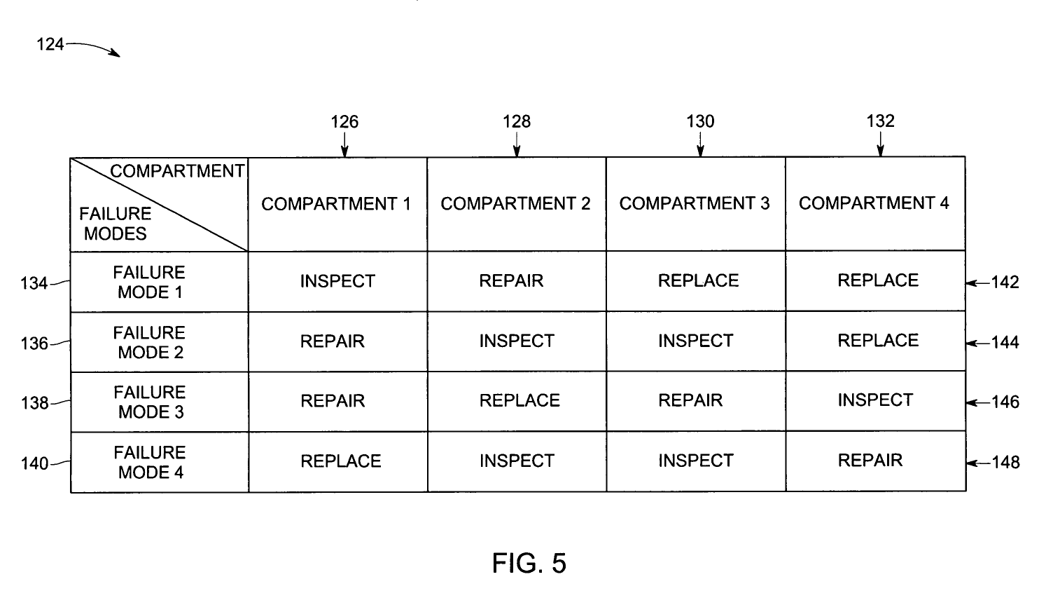

FIG. 5 illustrates an exemplary repair matrix 124 for an engine corresponding to different failure modes of the engine, in accordance with an exemplary embodiment of the present technique. The repair matrix includes repair strategies for a plurality of compartments of the engine such as 126, 128, 130 and 132 for a plurality of failure modes such as 134, 136, 138 and 140 respectively. In this exemplary embodiment, four failure modes 134, 136, 138 and 140 are considered for developing the repair matrix. However, lesser or greater number of failure modes may be envisaged.

In the illustrated embodiment, the repair matrix 124 includes repair strategies 142, 144, 146 and 148 corresponding to each of the failure modes 134, 136, 138 and 140 respectively. Each of the repair strategies 142, 144, 146 and 148 include actions such as repair of the compartment, inspection of the compartment or replacing the compartment. For example, if the engine is removed from the aircraft due to failure by the failure mode 134 then the repair strategy 142 includes replacing compartments 130 and 132, repairing compartment 128 and inspecting compartment 126. Similarly, different repair strategies 144, 146 and 148 may be employed for the failure modes 136, 138 and 140.

Moreover, each of the repair strategies 142, 144, 146 and 148 includes a cost of overhaul associated with the strategy. For example, if an engine is removed due to failure according to the failure-model 134 then the cost of overhaul may be given by the following equation:
Cost of overhaul=Cost of inspection of compartment 126+Cost of repair of compartment 128+Cost of replacement of compartment 130+Cost of replacement of compartment 132 (1)

Thus, a plurality of strategies such as repair strategies described above may be employed for managing the fleet of engines. Further, with different strategies the cost of overhaul and life improvement of each engine is different. For example, in the illustrated embodiment, the life and performance of the engine after overhauling in accordance with the strategy described above will be more than the life added to engine if the engine is just repaired for a current failure mode. As noted above, an optimal repair strategy for each engine is selected from the repair matrix 124 such that the life and performance requirements of the engine are met while minimizing the cost of overhaul. Particularly, based upon the current operating condition of the engine and the domain-dependent rules an optimal setting of the parameters may be selected to achieve a desired goal.

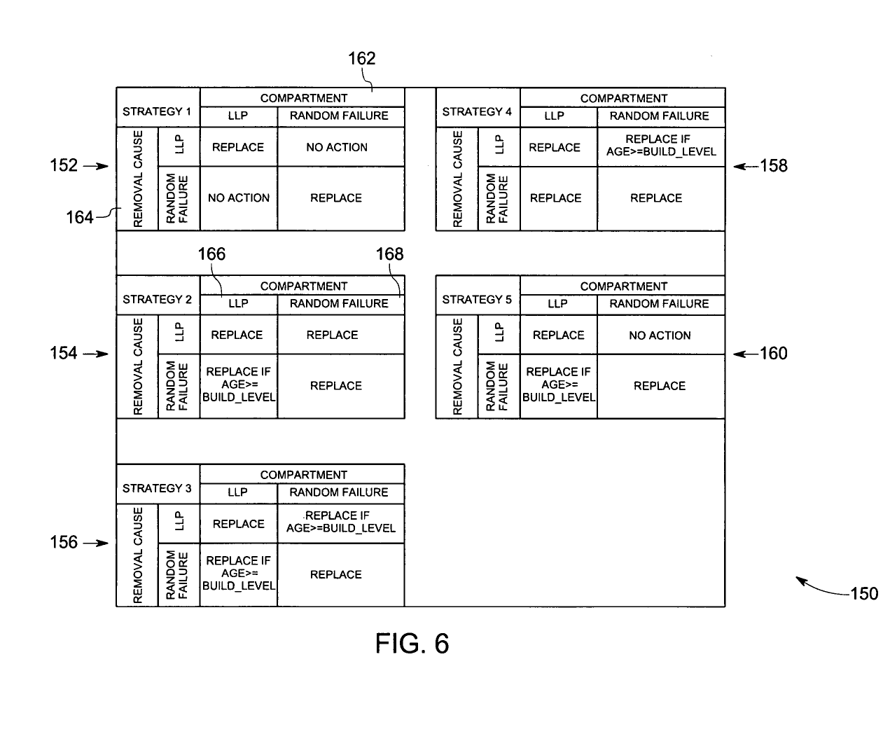

As seen above, a plurality of different strategies may be developed for an engine. FIG. 6 illustrates exemplary repair strategies 150 for an engine 14 subjected to random and life limiting part failure modes, in accordance with an exemplary embodiment of the present technique. In the illustrated embodiment, a plurality of repair strategies such as 152, 154, 156, 158 and 160 may be developed to overhaul the compartments of the engine. The repair strategy 152 includes repairing the failed component for a current failure mode only. In operation, the repair strategy 152 may require frequent shop visits of the engine that may increase the cost of overhaul and thus the cost of owning the engines. Further, the repair strategy 154 directs that if an engine is repaired for a life-limiting part failure then the engine may be repaired for random failures. Additionally, if the engine is repaired for random failure then repair the engine for a life limited part failure if it satisfies a pre-determined condition. Advantageously, the repair strategy 154 may be beneficial for maintaining the engine for a long time as it reduces the number of shop visits as well and hence reduce the cost of overhaul. Similarly, strategies 156, 158 and 160 employ different actions for the compartments of the engine.

In the illustrated embodiment, a strategy having an optimal setting of the parameters may be selected to minimize the cost of overhaul and hence owning the engines. Further, the optimal setting of the parameters may be applied to each of the engines 14 in the fleet to achieve customized rules and parameters for the respective engines 14. Subsequently, such customized rules and parameters are employed to repair and manage the engines 14 in the fleet.

The various aspects of the method described hereinabove have utility in different applications where asset management is desired. The technique illustrated above may be used for developing asset management strategy having rules corresponding to management of engines 14. Further, the parameters of the rules may be optimized to achieve the optimized parameters for the fleet that may be subsequently applied to individual assets for creating customized management plans for each of the asset.

As will be appreciated by those of ordinary skill in the art, the foregoing example, demonstrations, and process steps may be implemented by suitable code on a processor-based system, such as a general-purpose or special-purpose computer. It should also be noted that different implementations of the present technique may perform some or all of the steps described herein in different orders or substantially concurrently, that is, in parallel. Furthermore, the functions may be implemented in a variety of programming languages, such as C++or JAVA. Such code, as will be appreciated by those of ordinary skill in the art, may be stored or adapted for storage on one or more tangible, machine readable media, such as on memory chips, local or remote hard disks, optical disks (that is, CD's or DVD's), or other media, which may be accessed by a processor-based system to execute the stored code. Note that the tangible media may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of managing lifecycle costs of an asset inventory, comprising:
obtaining data related to assets for the asset inventory;
analyzing the obtained data to generate a plurality of domain-dependent rules having parameters corresponding to assets of the asset inventory;
determining an optimal setting of the parameters to achieve an estimated least-cost value of owning the assets over a period of time; and
applying the optimal setting of the parameters to each asset to generate customized asset parameters.

2. The method of claim 1, further comprising determining an optimal repair strategy for each asset based upon the domain-dependent rules and the operating conditions of the asset.

3. The method of claim 1, wherein the data related to assets comprise an asset utilization, or an asset lease acquisition cost, or an asset lease utilization cost, or an asset repair cost, or an asset life, or an asset maintenance turnaround time, or an asset transport time, or an asset depreciation, or an asset purchase cost, or an asset storage cost, or an asset ownership cost, or combinations thereof.

4. The method of claim 1, wherein the data related to assets comprises a plurality of failure modes of components of the assets.

5. The method of claim 4, wherein the plurality of failure modes comprise a gear box related failure, or a combustor failure, or a foreign object damage, or a high pressure compressor failure, or a high pressure turbine failure, or a life limited part, or a low pressure system failure, or a maintenance error, or a slow acceleration, or a control failure, or a performance failure, or combinations thereof.

6. The method of claim 1, wherein analyzing the obtained data comprises analyzing the obtained data to determine failure rate distributions for the components of the assets and forecasting failure of the components of the assets over the time period.

7. The method of claim 1, wherein determining the optimal setting of the parameters comprises estimating the optimal setting via a linear optimization program, or a heuristic method, or a genetic algorithm, or Simpex method, or steepest descent, or sequential programming, or energy minimization, or ant colony optimization, or simulated annealing.

8. The method of claim 1, further comprising employing a stochastic forecast to determine the cost of owning the assets over the time period.

9. A system for managing lifecycles costs for an asset inventory, comprising:
a database having data related to assets of the asset inventory;
an expert system comprising a plurality of domain-dependent rules corresponding to the assets of the asset inventory, wherein each of the domain-dependent rule is associated with a plurality of parameters; and
an optimization module configured to determine an optimal setting of the parameters to achieve an estimated least-cost value of owning the assets over a period of time.

10. The system of claim 9, wherein the data related to assets comprise an asset utilization, or an asset lease acquisition cost, or an asset lease utilization cost, or an asset repair cost, or an asset life, or an asset maintenance turnaround time, or an asset transport time, or an asset depreciation, or an asset purchase cost, or an asset storage cost, or an asset ownership cost, or combinations thereof.

11. The system of claim 9, wherein the data related to assets comprises a plurality of failure modes of components of the assets.

12. The system of claim 11, wherein the plurality of failure modes comprise a gear box related failure, or a combustor failure, or a foreign object damage, or a high pressure compressor failure, or a high pressure turbine failure, or a life limited part, or a low pressure system failure, or a maintenance error, or a slow acceleration, or a control failure, or a performance failure, or combinations thereof.

13. The system of claim 9, further comprising a processor configured to estimate the cost of owning the assets based upon the operating conditions of the asset and failure rate distributions for components of the assets.

14. The system of claim 13, wherein the processor comprises a simulator configured to determine the failure rate distributions for components of the assets over the time period.

15. The system of claim 9, wherein the optimization module employs a linear program, or a heuristic method, or a genetic algorithm to determine the optimal setting of the parameter.

16. The system of claim 9, wherein the optimization module is configured to determine an optimal repair strategy for each of the assets based upon an operating condition of the asset and the domain-dependent rules.

17. A tangible medium having a computer program for managing an asset inventory, comprising:
code for generating a plurality of domain-dependent rules having parameters corresponding to assets of the asset inventory based upon externally obtained data regarding the assets;
code for determining an optimal setting of the parameters to achieve an estimated least-cost value of owning the assets over a period of time; and
code for applying the optimal setting of the parameters to each asset to generate customized asset parameters.

18. The computer program of claim 17, further comprising code for estimating the cost of owning the assets over the time period based upon the operating conditions of the assets and failure rate distributions for components of the assets.

19. The computer program of claim 17, further comprising code for analyzing the obtained data to determine failure rate distributions for the components of the assets and forecasting failure of the components of the assets over the pre-determined period.

20. A method of managing an asset inventory, comprising:
obtaining data related to assets for the asset inventory; and
analyzing the obtained data to generate a plurality of domain-dependent rules having parameters corresponding to assets of the asset inventory, wherein an asset management strategy for the inventory is determined based upon an operating condition of the assets and the domain-dependent rules.

21. The method of claim 20, further comprising determining an optimal setting of the parameters to achieve an estimated least-cost value of owning the assets over a period of time and applying the optimal setting of the parameters to each asset to generate customized asset parameters.

22. The method of claim 20, wherein the data related to assets comprise an asset utilization, or an asset lease acquisition cost, or an asset lease utilization cost, or an asset repair cost, or an asset life, or an asset maintenance turnaround time, or an asset transport time, or an asset depreciation, or an asset purchase cost, or an asset storage cost, or an asset ownership cost, or combinations thereof.

23. The method of claim 20, wherein the data related to assets comprises a plurality of failure modes of components of the assets.

24. A tangible medium having a computer program for managing an asset inventory, comprising:
code for generating a plurality of domain-dependent rules having parameters corresponding to assets of the asset inventory based upon externally obtained data regarding the assets; and
code for determining an asset management strategy for the inventory based upon an operating condition of the assets and the domain-dependent rules.
